(19) United States
(12) Patent Application Publication
(10) Pub. No.: US 2024/0037531 A1
(43) Pub. Date: Feb. 1, 2024

(54) Digital Communications at Point-of-Sale

(71) Applicant: John Eric DeTitta, Fairport, NY (US)

(72) Inventor: John Eric DeTitta, Fairport, NY (US)

(21) Appl. No.: 18/217,145

(22) Filed: Jun. 30, 2023

Related U.S. Application Data
(62) Division of application No. 17/179,118, filed on Feb. 18, 2021, now abandoned.

(51) Int. Cl. G06Q 20/32

(52) U.S. Cl. CPC G06Q 20/3276; G06Q 20/3278

(57) ABSTRACT

Embodiments of a computer program product, a computer-implemented method, and a system are disclosed. A program code, executable on one or more client processors, is adapted to obtain a signal of decodable indicia from physical media at a point-of-sale. The program code decodes the decodable indicia signal, to access data from the decoded signal to automatically launch a web browser and navigate the browser to a unique uniform resource locator, where the code initiates an electronic transaction selected from the following group: (1) initiating an electronic commerce transaction, (2) accessing content posted at the resource locator, and (3) sending an electronic communication.

### CROSS REFERENCE TO RELATED APPLICATIONS

This application is a DIVISION of U.S. Ser. No. 17/179,118 filed Feb. 18, 2021, which is based on provisional application, U.S. Ser. No. 62/995,848 filed Feb. 18, 2020, incorporated by reference in their entirety for priority purposes, pursuant to 35 USC § 120.

### BACKGROUND

Point-of-sale interactions are frequent interactions between customers and service providers. Such interactions, generally purely transactional, do not extend any contact, interaction, or business relationship beyond payment for the services rendered. Given the frequency with which such transactions take place, the one-time nature of each such interaction is arguably a missed opportunity to form lasting or meaningful relationships.

### SUMMARY

Shortcomings of the prior art are overcome, and additional advantages provided, through provision of a method to facilitate electronic communications at a point-of-sale. The method includes: obtaining, by one or more processors of a computing device, a signal of decodable indicia. The signal of decodable indicia is obtained by the computing device from a physical medium at a point-of-sale. The method also includes decoding, by the one or more processors, the signal of decodable indicia to access decoded data, where, based on accessing the decoded data, the one or more processors automatically launch a web browser and navigate, based on the decodable data, to a unique uniform resource locator, where the uniform resource locator is specified by the decoded data. The method includes initiating, by the one or more processors, based on input through a graphical user interface by a user of the computing device, at the unique uniform resource locator, an electronic transaction, where the electronic transaction is selected from the group consisting of: initiating an electronic commerce transaction, accessing content posted at the uniform resource locator, and transmitting an electronic communication.

Shortcomings of the prior art are also overcome, and additional advantages provided, through the provision of a system to facilitate electronic communications at a point-of-sale. The system includes: a memory; one or more processors in communication with the memory; and program instructions executable by the one or more processors via the memory to perform a method. This method comprises: obtaining, by one or more processors of a computing device, a signal of decodable indicia. The signal of decodable indicia is obtained by the computing device from a physical medium at a point-of-sale. This method includes: decoding, by the one or more processors, the signal of decodable indicia to access decoded data. Based on the decoded data accessed, one or more processors automatically launch a web browser and navigate, based on the decodable data, to a unique uniform resource locator, specified by the decoded data. This method further includes initiating, by the one or more processors, based on input through a graphical user interface by a user of the computing device, at the unique uniform resource locator, an electronic transaction, where the electronic transaction is selected from the group consisting of: initiating an electronic commerce transaction, accessing content posted at the uniform resource locator, and transmitting an electronic communication.

Shortcomings of the prior art are overcome, and additional advantages provided, through provision of a computer program product to facilitate electronic communications at a point-of-sale. The computer program product includes a computer readable storage medium readable by one or more processors and storing instructions for execution by the one or more processors for performing a method comprising: obtaining, by one or more processors of a computing device, a signal of decodable indicia, the signal of decodable indicia being obtained by the computing device from a physical medium at a point-of-sale; decoding, by the one or more processors, the signal of decodable indicia to access decoded data, where, based on accessing the decoded data, the one or more processors automatically launch a web browser and navigate, based on the decodable data, to a unique uniform resource locator, where the uniform resource locator is specified by the decoded data; and initiating, by the one or more processors, based on input through a graphical user interface by a user of the computing device, at the unique uniform resource locator, an electronic transaction, where the electronic transaction is selected from the group consisting of: initiating an electronic commerce transaction, accessing content posted at the uniform resource locator, and transmitting an electronic communication.

Assorted systems, computer program products, and computer-implemented methods relating to one or more aspects of the techniques of the present subject matter are also described and may be claimed herein. Furthermore, a variety of services relating to one or more aspects of the techniques are also described and may be claimed herein.

Additional advantages and features of the presents subject matter are realized through the techniques of the present invention. Other embodiments and aspects of the invention are described in detail herein and are considered a part of the claimed invention.

### BRIEF DESCRIPTION OF THE DRAWING FIGURES

The foregoing aspects, features, advantages, and examples of the present subject matter will become apparent from the following detailed description in connection with the drawing figures; and at least one of the aspects, features, and advantages of the present subject matter, is particularly pointed out and distinctly claimed in the appended claims.

FIG. 1 depicts a technical environment into which aspects of certain embodiments of the present subject matter have been implemented.

FIG. 2 presents a workflow that illustrates various aspects of certain embodiments of the present subject matter.

FIG. 3 presents another workflow that illustrates various aspects of certain embodiments of the present subject matter.

FIG. 4 depicts a computer system configured to perform an aspect of an embodiment of the present subject matter.

FIG. 5 depicts a computer program product incorporating one or more aspects of the present subject matter.

FIG. 6 is an example of a screenshot of a secure website which a service provider can utilize to establish a profile and which a customer can access to continue interactions with the service provider, including but not limited to tipping the service provider.

FIG. 7 presents an example of a screenshot of an ecommerce store which a service provider can utilize to purchase items that include a signal of decodable indicia.

FIG. 8 is an example of a sign-up page which a user can utilize to establish a URL (e.g., a webpage on the secure website), to which decoding a signal of decodable indicia will direct a customer.

FIG. 9 presents an illustrative workflow from the point-of-view of a service provider.

### DETAILED DESCRIPTION

Aspects of the present subject matter including certain features, advantages, and details explained more fully below with reference to non-limiting examples illustrated in the accompanying drawings. Descriptions of well-known materials, fabrication tools, processing techniques, etc., are omitted to not unnecessarily obscure the present subject matter in detail. It should be understood, however, that the detailed description and the specific examples, while indicating aspects of the present subject matter, are given by way of illustration only, and not by way of limitation. Various substitutions, modifications, additions, and/or arrangements, within the spirit and/or scope of the underlying inventive concepts will be apparent to those skilled in the art from this disclosure. The terms software and program code are used interchangeably throughout this patent specification and can refer to logic executed by both hardware and software. Components of the system utilized to execute aspects of embodiments of the present subject matter may include specialized hardware, including but not limited to, a GPP, a field-programmable gate array (“FPGA”), and a graphics processing unit (“GPU”). Additionally, items denoted as processors may include hardware and/or software processors or other processing means, including but not limited to a software defined radio and/or custom hardware.

Embodiments of the present subject matter include methods, systems, and computer program products that enable digitally extending what are, generally, brief interactions between individuals involved in point-of-sale transactions. Embodiments of the present subject matter include one or more processors generating a graphical user interface (“GUI”) (e.g., a thin client or a thick client) that one participant in the transaction can utilize to upload content. Meanwhile, the other individual involved in the transaction is provided with a signal of decodable indicia, e.g., a quick response (“QR”) code, a bar code, an RFID, etc., allowing a user to access content uploaded by the first individual. The examples show users can extend interactions to form social networking connections.

Embodiments of the present subject matter are inextricably linked to computing, provide a practical application for users, and offer significantly more than existing online secure-payment methods and means for connecting to individuals via social media. Embodiments of the present subject matter include, but are not limited to, assorted computer-implemented methods, computer program products, and computer-based systems that connect customers, in real-time, to service providers, such as tipped workers and performers, all of which enable these users to maintain their assorted connections after the associated services have been provided (e.g., after a point-of-sale transaction).

Embodiments of the present subject matter are inextricably linked to computing at least because embodiments of the present subject matter utilizing a software program to generate a unique signal of decodable indicia. Signals of decodable indicia may include, but are not limited to bar codes, RFIDs, QR codes, etc. Throughout this disclosure, a QR code is provided as an example of a signal of decodable indicia, but this is just one example and is provided for illustrative purposes, only. Thus, as understood by one of skill in the art, examples herein, illustrated by use of unique QR codes, are also useable with other types of signals of decodable indicia. Embodiments are inextricably linked to computing as they generate and utilize unique QR codes and utilize an image capture device, such as a camera, to read a QR code, as well as one or more software programs to decode the QR code. Further, embodiments are inextricably linked to computing at least because embodiments of the present subject matter utilize a device to run the software programs and visualize the resulting data in the QR code, e.g., a link to a website. In certain embodiments, the device may be a smart phone with a camera, wherein the camera may be used to read the QR code, and the smart phone may run the software program to decode the QR code. Embodiments of the present subject matter are also inextricably linked to computing, as one aspect of embodiments disclosed herein, a linkage between a unique identifier and a website or other application to provide content uploaded by a user to an individual utilizing the unique identifier (a signal of decodable indicia) as a link, is wholly provided (enabled and provided) on a computing platform. From the generation of the QR code, the decoding of the QR code, the generation of the application, and the navigation to the application based on decoding the QR code, all such aspects of this part of the disclosure rely on a backbone of computing technologies.

Embodiments of the present subject matter have a practical application at least to the extent that the system enables instantaneous, e.g., real-time and/or new real-time, and secured-tipping online at the location where the select services are provided. Certain practical aspects of some embodiments of the present subject matter include providing a central location for service providers to create a user profile that expresses their goals and relates their experiences to customers. As explained herein, the user profile allows the service provider to share their stories and to brand their connectors with their name and unique QR code. Additionally, embodiments of the present subject matter provide a practical application because the system enables a customer to connect with service providers and to maintain and/or grow that connection after service has been provided.

A practical applicability of assorted embodiments of the present subject matter are particularly observable in a situation where a service provider has performed appropriate services and the customer now desires to provide a tip but does not have cash on hand. Additionally, whenever the customer wishes to subsequently engage the service provider again, the system enables an enduring connection to be formed at a time of performance (e.g., at the point-of-sale) which can be maintained, if desired, after provision of a service. Embodiments of the system immediately, i.e., in real-time (or almost real-time), provide a customer with a way to securely tip the service provider and to follow the service provider. Furthermore, the QR code may be placed on a wide range of “connectors” such as products or advertising, at a location where service is provided for allowing instant access to information about the service provider and for securely tipping for services performed.

A practical applicability of embodiments of the present subject matter is particularly observable in a situation where the service provider is an independent performer and the service provided is, e.g., a live performance. If the service provider places “connectors,” which are branded, for example, with its name and unique QR code, around the location of the performance, then a customer who enjoyed the performance but lacks cash on hand to provide a tip, or doesn't have time to leave one, may instead quickly scan the QR code and be instantly connected, via the internet, to the performer. Thus, the customer would see the performer's profile and could leave a tip, at any time, and from any place.

Embodiments of the present subject matter include an assortment of features and aspects that offer significantly more than existing online secure-payment methods and systems, for connecting to individuals via social media. Such aspects will be discussed in greater detail below. Unlike many existing online secure-payment methods and systems to connect individuals via social media, for select embodiments of the present subject matter, an online secure-payment method is directly coupled to a social media connection and is not a one-off event to render payment. In addition, branded content and QR codes could appear on products, e.g., business cards, badges, tip jars, etc., in a such way that a customer has a direct link to a service provider's website, for instant and secure digital tipping, and for forming a connection through videos and stories on a service provider's profile. Such a connection promotes interactions and may strengthen feelings of loyalty.

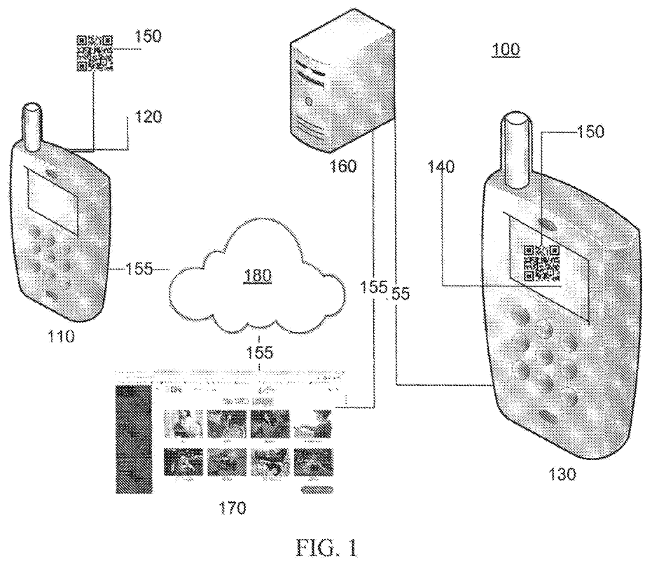

FIG. 1 exemplifies a technical environment 100 into which aspects of certain embodiments of the present subject matter can be implemented. The technical environment 100 includes a computing device 110 with a facility to capture and decode signals of decodable indicia 120. These facilities may include an image capture device, a scanner, and one or more programs executed by the processor(s) of the computing device 110, which decode the signals or images captured by the facility 120. The facility 120 can include hardware and/or software. The technical environment 100 also includes a second computing device 130, which executes a graphical user interface (“GUI”) 140, which enables a user of this device 110 to request generation of a unique signal of decodable indicia 150. The user could receive a unique signal of decodable indicia 150 and place the unique signal of decodable indicia 150 on physical media at a point of sale (e.g., business cards, a placard, a tip jar, a badge, etc.). The unique signal of decodable indicia 150 could be generated by one or more servers 160 (such servers could be part of either of the computing devices and/or separate). The servers 160 are communicatively coupled 155 to the second computing device 130. For ease of understanding, a variety of different types of network connections 155 in the technical environment 100 could be labeled with the same signifier. In certain embodiments of the present subject matter, the application (executed by the servers), generating the unique signal of decodable indicia, also includes a store that offers, for purchase, items that include a signal of decodable indicia. When a user requests generation of a signal of decodable indicia, the user can also purchase items that include the signal of decodable indicia. These items can be understood as “connectors.” Upon receiving a request for the GUI 140 to generate a unique identifier, the one or more servers 160 also generate a URL (a given location or webpage on a website 170) and provide access to the user to this URL, for uploading content. Decoding the signal of decodable indicia navigates the device utilized to decode the signal to this URL. The first-identified computing device 110 can access the URL over Internet 180, including based on decoding the QR code and being redirected to the URL.

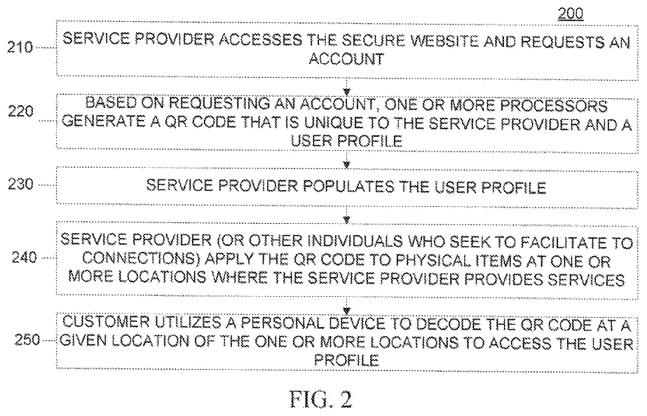

FIG. 2 is a workflow 200 illustrating various aspects of certain other embodiments of the present subject matter. Specifically, workflow 200 illustrates how aspects of certain embodiments of the present subject matter can be utilized to create a connection between a customer and a service provider. This connection, which as explained herein, can move the communications of the customer and the service provider beyond brief point-of-sale transactions, that enable, for example, digital tipping through QR placement on a product. As explained above, a QR code could be utilized in examples of one signal of decodable indicia that could be employed in assorted embodiments of the present subject matter.

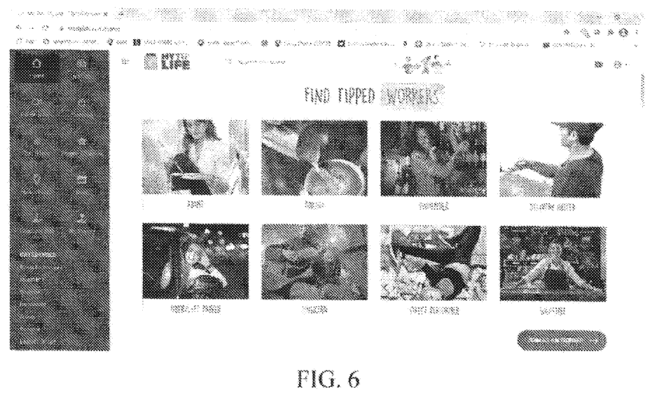

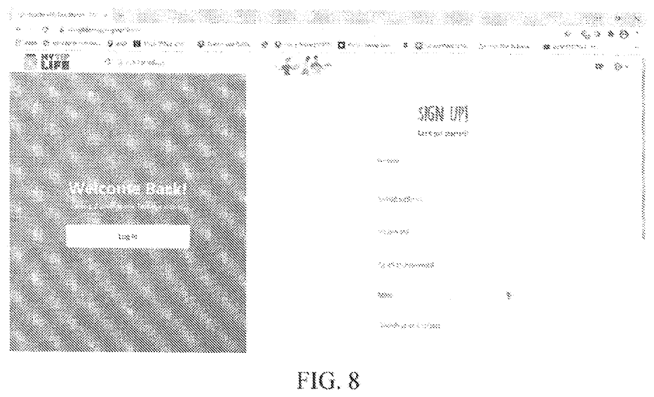

Returning briefly to FIG. 2, aspects in accordance with certain embodiments of the present subject matter are utilized to form a connection between a customer and a service provider. For ease of understanding, these aspects are compartmentalized into individual sections, but may contain additional sub-aspects in accordance with select embodiments. Referring still to FIG. 2 (for steps noted below), a Service Provider accesses the secure website and requests an account (step 210). FIG. 6 provides an example of an interface for this type of secure website and FIG. 8 provides a further example of a screen that a Service Provider could navigate, for requesting an account; and based the requested account, one or more processors generate a QR code which is unique to the Service Provider as well as a user profile, at a unique URL (after the QR code is de-coded), to which a customer is directed (step 220). A Service Provider populates the user profile by, e.g., uploading content, including but not limited to, stories, goals, video, audio, and text (step 230). In embodiments of the present subject matter, Service Providers individually request a user profile and QR code upon accessing the secure website (or application). In some embodiments, once the user has completed populating the profile (determined automatically or based on user input), the one (or more) processors automatically generate the QR code. The Service Provider (or other individuals who seek to “connect to” connections) applies the QR code to physical items at one or more locations where the Service Provider provides services (step 240). A Customer utilizes a personal device to decode the QR code at a given location of the one or more locations to access the user profile (step 250). Accessing the user profile, in certain of these examples, enables the Customer to access securely tip the Service Provider and/or share in the experiences of the Service Provider through stories, videos, etc. on the Service Provider's profile page. The tipping mechanism can be hosted by the secure website and utilized by account holders (service providers), to enable customers to tip the service providers more easily.

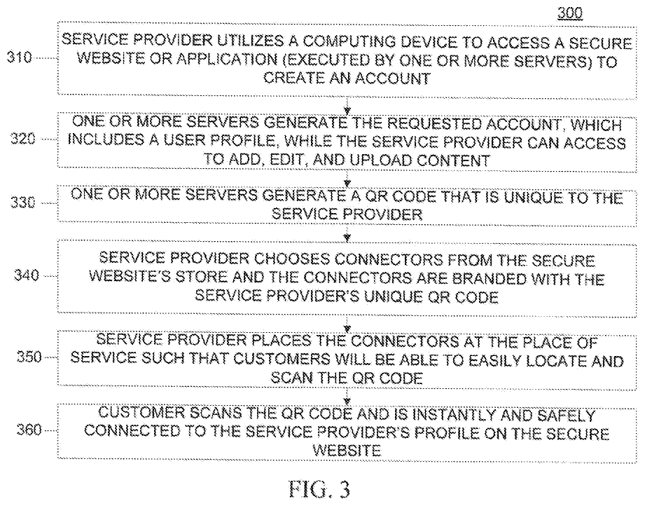

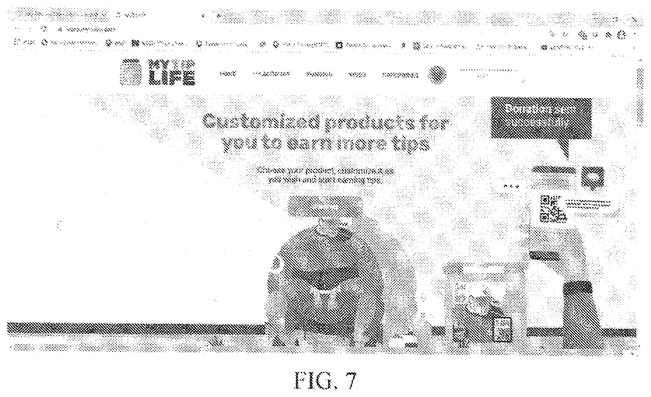

FIG. 3 presents a workflow 300 that expands when triggered by a connection that could be formed between a service provider and a customer. FIG. 3 (another method) also uses the example of how such a connection could be used, among other possibilities, for digital tipping. Referring more particularly now to FIG. 3, various aspects of certain embodiments of the present subject matter would enable formation of a connection (beyond a point-of-sale or point-of-service interaction) between a service provider and a customer. In certain embodiments of the present subject matter, a Service Provider may utilize a computing device to, for example, access a secure website or application (executed by one or more servers) to create an account (step 310). The one or more servers generate the requested account, which includes a user profile, while the Service Provider can access to add, edit, and upload content, e.g., audio, video, text, stories, goals, and electronic payment links (step 320). The one or more servers generate a QR code that is unique to the Service Provider (step 330). The Service Provider could choose connectors from the secure website's store and the connectors could be branded with the Service Provider's unique QR code and, optionally, a Service Provider's name (step 340). FIG. 7 presents a screenshot of an example of a web store that a Service Provider could navigate, for purchasing select connectors. The connectors could be various products including but not limited to business cards, tip jars, badges, etc. The Service Provider could place connectors at a place-of-service such that customers are able to easily locate and scan the QR code (step 350). The customer can scan the QR code and then instantly and safely be connected to a Service Provider profile on a secure website (step 360). The customer could, thereafter, choose to maintain a connection with that Service Provider by following a profile of that Service Provider on a secure website or perhaps deepen a connection by watching videos or reading stories posted by a Service Provider, if desired.

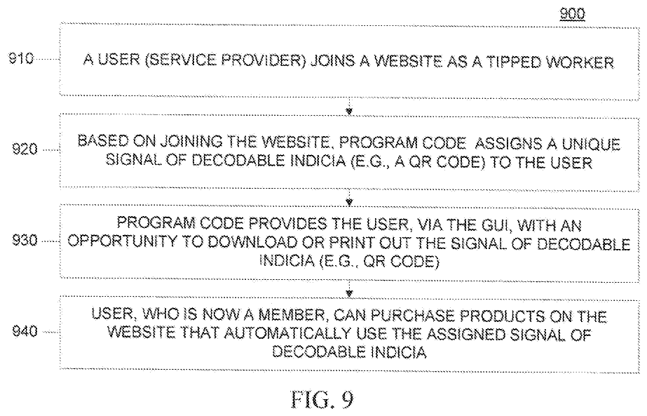

FIG. 9 is a workflow (another method 900) from a point of view of a service provider as a user. As depicted in FIG. 9, a user joins a website as a tipped worker (step 910). FIG. 6 shows an example of a homepage for this website and a link to “join as worker” which the user may select, to join (step 910). Meanwhile, FIG. 8 depicts a webpage which can be the destination of the “join as worker” link in FIG. 6. The webpage represented in FIG. 8 is a first signup page, and is provided as an illustrative example, which a user can utilize to join the website. The user would fill out “fields” in this GUI to become a member. Based on joining the website, the program code (executing on one or more processors), assigns a signal of decodable indicia (e.g., a QR code) to the user (step 920). Then, the program code provides the user, via the GUI, with an opportunity to download or print out the signal of decodable indicia, e.g., QR code (step 930). The user, who is now a member, can purchase products on the website that automatically use the assigned signal of decodable indicia (step 940). An example of a page which a user can utilize to purchase these products (e.g., business cards, badges, tip jars, wearable items, placards, etc.) is depicted in FIG. 7. The listed products are provided as non-limiting examples, for illustrating aspects and features of embodiments of the present subject matter and not imposing any limitations. As explained, in certain embodiments of the present invention, when a user scans a signal of decodable indicia, or otherwise utilizes a computing device to capture and decode the signal of decodable indicia, the computing device of the user (e.g., a phone), will navigate to the member-user's profile on the website. The program code will then display a “tip me” button on the profile page such that the customer can tip the member-user and/or otherwise interact with content uploaded by the member-user.

Embodiments of the present subject matter include a computer implemented method, a computer program product, and a computer system, where one or more programs executed on one or more processors obtain a signal of decodable indicia. A signal of decodable indicia is obtained by the computing device from a physical medium at a point-of-sale. The one or more programs decode the signal of decodable indicia to access decoded data, where based on accessing decoded data, one or more processors automatically launch a web browser and navigate, based on the decodable data, to a unique uniform resource locator, where the uniform resource locator is specified by the decoded data. Based on input (via a graphical user interface) by a user of the computing device, the one or more programs initiate an electronic transaction, at the unique uniform resource locator, where the electronic transaction is selected from the group consisting of one of the following: initiating an electronic commerce transaction, accessing content posted at the uniform resource locator, and transmitting an electronic communication.

In certain embodiments of the present subject matter, the signal of decodable indicia could be selected from the group consisting of one of the following: a quick response code, a bar code, and a radio frequency identification.

In certain embodiments of the present subject matter, the signal of decodable indicia is unique.

In embodiments of the present subject matter, obtaining a signal of decodable indicia comprises using an image capture device on a computing device to capture an image of the signal of decodable indicia, wherein based on capturing the image, the one or more processors are adapted to automatically decode the signal of decodable indicia.

In certain embodiments of the present subject matter, the signal of decodable indicia is unique and generated by one or more servers.

In certain embodiments of the present subject matter, the physical medium located at the point-of-sale could be selected from the group consisting of one of the following: a business card, a wearable item, and a tip jar.

In certain embodiments of the present subject matter, the electronic transaction comprises accessing content posted at the uniform resource locator and the content could be selected from the group consisting of one of the following: video, audio, and text.

In certain embodiments of the present subject matter, the physical medium could be placed at the point-of-sale by a user who posted the content at the uniform resource locator. The user could have transmitted, via a personal computing device, a command to one or more servers, for the purpose of generating the signal of decodable indicia.

In certain embodiments of the present subject matter, the one or more servers generating the signal of decodable indicia could further comprise the one or more servers generating the uniform resource locator, which could include a webpage at the uniform resource locator. The webpage could then be utilized by the user to upload the content.

In certain embodiments of the present subject matter, the computing device could be selected from the group consisting of one of the following devices: a wearable device, an implanted device, a handheld device, and a stationary device.

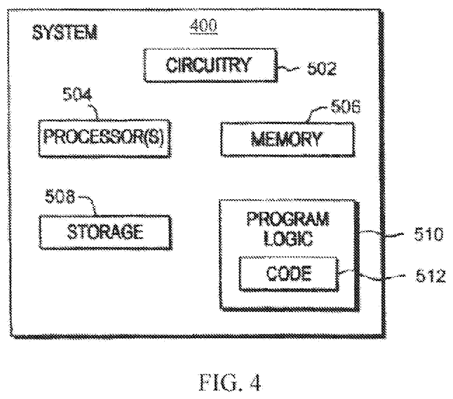

FIG. 4 illustrates a block diagram of a resource 400 in a computer system of the present subject matter (including the computing devices discussed above), which could be part of the technical architecture of the present subject matter. In FIG. 4, resource 400 may include a circuitry 502 which may, in certain embodiments, include a microprocessor 504. Computer system 400 may include memory 506 (e.g., a volatile memory device), and storage 508. Storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 400 may further include a program logic 510 including code 512 that could be loaded into the memory 506 and executed by the microprocessor 504 or circuitry 502.

In certain embodiments of the present subject matter, program logic 510 including code 512 may be stored in storage 508, or memory 506. In certain other embodiments, the program logic 510 may be implemented in circuitry 502. Therefore, while FIG. 4 shows program logic 510 separately from the other elements noted, the program logic 510 may be implemented in memory 506 and/or in circuitry 502. Program logic 510 therefore may include program code discussed in this specification which facilitates a reconfiguration of elements of various computer networks, including those presented in assorted figures.

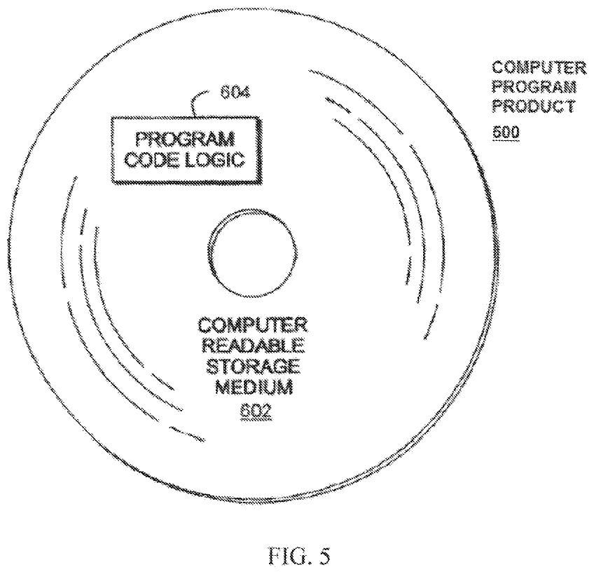

Using processing resources of a resource 400 to execute software, computer readable code, or instructions, this code can be stored without limit. Referring to FIG. 5, a computer program product 500 includes, for example, one or more non-transitory computer readable storage media 602 to store computer readable program code means or logic 604 thereon, for providing and facilitating one or more aspects of the technique.

As will be appreciated by those skilled in the art, aspects of the technique could be embodied as a system, a method, or a computer program product. Aspects of the technique could take the form of an entirely hardware-based embodiment, an entirely software-based embodiment (including firmware, resident software, micro-code, etc.) or an embodiment combining software and hardware aspects, all of which generally may be referred to as a “circuit,” a “module,” or a “system.” Furthermore, aspects of the technique could take the form of a computer program product embodied in one or more computer readable media having computer readable program code embodied therein or thereon.

Any combination of one or more computer readable medium may be utilized in accordance with principles of the present subject matter. The computer readable medium could be a computer readable signal medium or a computer readable storage medium. A computer readable signal medium could include a propagated data signal with computer readable program code embodied therein, for example, in baseband or as part of a carrier wave. Such a propagated signal could take any of a variety of forms, including, but not limited to, electro-magnetic, optical or any suitable combination thereof. A computer readable signal medium could be any computer readable medium that is not a computer readable storage medium and that can communicate, propagate, or transport a program for use by, or in connection with, an instruction execution system, apparatus or device.

Computer readable storage media of the present subject matter, e.g., could include (but not be limited to) an electronic, a magnetic, an optical, an electromagnetic, an infrared or a semiconductor system, apparatus, or device, or any suitable combination of the foregoing. More specific examples (including a non-exhaustive list) of computer readable storage medium of the present subject matter could include at least one of the following: an electrical connection having one or more wires, a portable computer diskette, a hard disk, a random access memory (“RAM”), a read-only memory (“ROM”), an erasable and programmable read-only memory (an EPROM or a Flash memory), an optical fiber, a portable compact disc having read-only memory (CD-ROM), an optical storage device, a magnetic storage device, or any suitable combination of the foregoing. In the context of this patent specification, a computer readable storage medium in accordance with the present subject matter may be any tangible medium that can contain or store a program for use by, or in connection with, an instruction execution system, apparatus, or device.

Any combination of one or more computer readable media may be used. Computer readable media could be a computer readable signal medium or a computer readable storage medium. Computer readable signal media may include a propagated data signal with computer readable program code embodied therein, for example, in baseband or as part of a carrier wave. A propagated signal may take any of a variety of forms including, but not limited to, electromagnetic, optical or any suitable combination thereof. Computer readable signal medium may be any computer readable medium that is not a computer readable storage medium and that can communicate, propagate, or transport a program for use by, or in connection with, an instruction execution system, apparatus or device.

Program code embodied on a computer readable medium, pursuant to the present subject matter, may be transmitted using an appropriate medium, including but not limited to wireless, wireline, optical fiber cable, RF, or any suitable combination of the foregoing.

Computer program code for carrying out operations for aspects of the technique could be written in any combination of one or more programming languages, including an object-oriented programming language, such as Java, Smalltalk, C++ or the like, and conventional procedural programming languages, e.g., “C” programming language, PHP, ASP, assembler or similar programming languages, as well as functional programming language and language for technical computing (e.g., Python, Matlab). The program code may execute entirely on a user's computer, partly on a user's computer, as a stand-alone software package, partly on a user's computer and partly on a remote computer or entirely on a remote computer or server. In the latter scenario, the remote computer could be connected to the user's computer through any type of network, including a local area network (“LAN”) or a wide area network (“WAN”), or the connection could be made to an external computer (for example, through the Internet using an Internet Service Provider). Furthermore, more than one computer can be used for implementing the program code, including, but not limited to, one or more resources in a cloud-computing environment.

Aspects of the technique are described herein with reference to flowchart illustrations and/or block diagrams of methods, apparatus (systems) and computer program products, in accordance with embodiments of the present subject matter. It will be understood that each block of the flowchart illustrations and/or block diagrams, and combinations of blocks in the flowchart illustrations and/or block diagrams, could be implemented by computer program instructions. The computer program instructions could be provided to a processor of a general-purpose computer, a special purpose computer, or other programmable data processing apparatus for producing a machine, such that the instructions, which can be executed via a processor of a computer or other programmable data processing apparatus, could create means or systems for implementing functions and/or acts specified within a flowchart and/or one or more blocks of a block diagram.

Computer program instructions, also referred to as software and/or program code, can be stored in computer readable media that can direct computers, other programmable data processing apparatus, or other devices to function in a manner so that instructions stored in computer readable media produce an article of manufacture (and instructions) to implement functions/acts specified in a flowchart and/or block diagram block or blocks.

The computer program instructions could also be loaded onto a computer, other programmable data processing apparatus, or other devices, for causing a series of operational steps to be performed on the computer, or another programmable apparatus, or other devices to produce a computer implemented process, whereby the instructions—which execute on the computer or other programmable apparatus—provide processes for implementing functions and/or/acts specified in the flowchart and/or block diagram.

The flowchart and block diagrams in the accompanying figures illustrate the architecture, functionality, and operation of possible implementations of systems, methods and computer program products according to various embodiments of the technique of the present subject matter. In this regard, each block in the flowcharts or block diagrams may represent a module, segment, or portion of code, which comprises one or more executable instructions for implementing the specified logical function(s). It should also be noted, in some alternative implementations, that the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, one or more aspects of the technique may be provided, offered, deployed, managed, or serviced by a service provider offering customer environments. For instance, a service provider can create, maintain, or support computer code and/or a computer infrastructure performing one or more aspects of the technique for one or more customers. In return, a service provider may, e.g., receive payment from a customer under a subscription and/or fee agreement. Also, or alternatively, a service provider could receive payment from the sale of advertising content to at least one or more third parties.

In one aspect of the technique, an application may be deployed to perform one or more aspects of the technique. As an example, the deploying of an application comprises providing computer infrastructure operable to perform at least one aspect of a technique.

As a further aspect, a computing infrastructure could be deployed for integrating computer readable code into a computing system in which certain code in combination with a certain computing system is able to perform one or more aspects of the technique.

As yet a further aspect of the noted technique, a process for integrating computing infrastructure could include integrating computer readable code into a computer system. The computer system may comprise a computer readable medium in which the computer medium could comprise one or more aspects of the technique. The code, in combination with such a computer system, could perform one or more aspects of the noted technique.

Furthermore, still other types of computing environments could benefit from one or more aspects of techniques of the present subject matter. As an example, an environment may include an emulator (e.g., software or other emulation mechanisms), in which a particular architecture (including, for instance, instruction execution, architected functions, such as address translation, and architected registers) or a subset thereof, is emulated (on, e.g., a native computer system having a processor and memory). In such an environment, one or more emulation functions of the emulator can implement one or more aspects of the technique, even though a computer executing the emulator may have a different architecture than the various capabilities being emulated. As one example, in emulation mode, the specific instruction or operation being emulated is decoded, and an appropriate emulation function is built to implement the individual instruction or operation.

In an emulation environment, a host computer includes, e.g., a memory to store instructions and data; an instruction fetch unit to fetch instructions from memory and, optionally, to provide local buffering for fetched instructions; an instruction decode unit to receive the fetched instructions and determine type of instructions that have been fetched; and an instruction execution unit to execute the instructions. Execution may include loading data into a register from memory; storing data back to memory from a register; or performing an arithmetic or logic operation, as determined by the decode unit. In embodiments, units are software-implemented. For instance, operations being performed by the units noted are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least certain program code, for reducing the number of times code must be retrieved from bulk storage during execution.

Input/Output (or “I/O”) devices including, but not limited to, keyboards, displays, pointing devices, DASD, tape, CDs, DVDs, thumb drives and other memory media, etc. could be coupled to a system either directly or through intervening Input/Output (or “I/O”) controllers. Network adapters could also be coupled to the system to enable such data processing systems to become coupled to other data processing systems or remote printers or storage devices through intervening private or public networks. Modems, cable modems, and Ethernet cards are just a few of the available types of network adapters.

Terminology used throughout this specification to describe embodiments is not intended to be limiting. As used, singular forms “a,” “an,” and “the” are intended to include plural forms as well, unless their context clearly indicates otherwise. It should be further understood that the terms “comprise,” “comprises,” and “comprising,” throughout this specification, specify a presence of stated features, integers, steps, operations, elements, and/or components, but do not preclude the presence or addition of one or more other features, integers, steps, operations, elements, components including groups thereof.

The corresponding structures, materials, acts, and equivalents of all means or steps including functional elements in descriptions herein (if any are intended) include any structure, material, or acts, for performing functions recited in combination with other elements as specifically noted. Descriptions of such techniques have been presented for purposes of illustration and description and are not intended to be exhaustive or limited to the present subject matter, in embodiments disclosed. Accordingly, modifications and variations shall become apparent to a person of ordinary skill in the art, which do not depart from the scope and spirit of the present subject matter. Embodiments were chosen and described, to disclose principles and practical applications of the present subject matter, and to enable a person of ordinary skill in the art to understand the embodiments and how certain modifications are suited to an assortment of potential uses contemplated.

I claim:

1. A computer-implemented digital communications system comprising:
a computing device including:
an image-capture device for capturing an image and
a memory device operatively associated with the image-capture device,
wherein the memory device is adapted and configured to store the image,
wherein the image contains a decodable signal for a point-of-sale location;
one or more data processors operatively connected to the image-capture device and the memory device, wherein the one or more data processors are adapted and configured to:
access a secure website or application executed by one or more servers adapted and configured to create a secure service provider account and
decode a decodable signal, access decoded data derived from the decodable signal, launch a web browser, and navigate automatically to a uniform resource locator (“URL”) associated with the decoded data; and
an interface adapted and configured to enable a user electronically to transfer a predetermined fund amount from a user account to the secure service provider account and to select a recipient associated with the URL, for transferring funds.

2. The computer-implemented digital communications system of claim 1, wherein the recipient is a select service provider, and wherein the predetermined fund amount is a predetermined monetary tip amount for services rendered by the select service provider to a customer.

3. The computer-implemented digital communications system of claim 2, wherein the decodable signal at the point-of-sale location is contained within a bar code.

4. The computer-implemented digital communications system of claim 2, wherein the decodable signal at the point-of-sale location is contained within a radio frequency identification (“RFID”) code.

5. The computer-implemented digital communications system of claim 2, wherein the decodable signal at the point-of-sale location is contained within a quick response (“QR”) code.
